(19) United States
(12) Patent Application Publication
(10) Pub. No.: US 2010/0293491 A1
(43) Pub. Date: Nov. 18, 2010

(54) Information Processing Apparatus, System, And Program

(75) Inventor: Yoshifumi KAWAI, Kanagawa (JP)

Correspondence Address: COOPER & DUNHAM, LLP, 30 Rockefeller Plaza, 20th Floor, NEW YORK, NY, 10112, US

(73) Assignee: RICOH COMPANY, LTD., Tokyo (JP)

(21) Appl. No.: 12/777,520

(22) Filed: May 11, 2010

(30) Foreign Application Priority Data
May 12, 2009 (JP) 2009-115813

(51) Int. Cl. G06F 9/445; G06F 3/048

(52) U.S. Cl. 715/771; 717/178

(57) ABSTRACT

The disclosed information processing apparatus is connected to a plug-in server accumulating plug-ins and a plug-in configuration management server managing a plug-in configuration of the information processing apparatus via a network, whereby the information processing apparatus includes a function change unit installing the plug-ins acquired from the plug-in server in the information processing apparatus, a memory unit storing configuration information of the plug-ins, a registration unit registering the configuration information in the plug-in configuration management server, and a determination unit comparing the configuration information to determine a difference between the plug-ins installed in the information processing apparatus and the plug-ins installed in another information processing apparatus, whereby the function change unit determines and acquires a missing plug-in with reference to the difference from the plug-in server, and additionally installs the missing plug-in in the information processing apparatus.

### BACKGROUND OF THE INVENTION

1. Field of the Invention

The present invention generally relates to information processing such as an information processing apparatus, an information processing system, and an information processing program.

2. Description of the Related Art

An example of an image forming apparatus has plural functions such as a copier and a scanner. In recent years, the example of the image forming apparatus has also included a multi-function peripheral (MFP). The MFP provides various utilization modes of not only a digital copier but also transmission of data such as images and documents through a network or by a facsimile in association with tendencies of CPU performance upgrade, a higher capacity in memories, faster communication, sophistication of digital image technology and technology advancement in the MFP.

Meanwhile, applications for providing functions of the image forming apparatuses can be customized in conformity with users' tastes with various measures. For example, controller software is designed with the emphasis on easiness of customizing functions provided by the image forming apparatuses. Because the applications have plug-in functions, the users can purchase any of the applications corresponding to a required plug-in function for installing it in the image forming apparatus. In this way, the functions may be easily installed in or uninstalled from the image forming apparatuses.

When the image forming apparatus undergoes an addition or a change of plug-in, it is necessary to ensure consistency between the image forming apparatus and the plug-in to prevent available functions from being disabled. Patent Document 1 discloses a technique in which plural software functions are installed as a plug-in in an image forming apparatus, and consistency between the image forming apparatus and the plug-in is ensured in order to prevent previously available functions from being disabled. Specifically, when the hardware configuration of the image forming apparatus is changed, a server is queried whether the current plug-in configuration can be applied to the image forming apparatus with its hardware configuration changed to determine the applicability of the current plug-in configuration.

The image forming apparatuses are widely used in office environments or the like. Plug-in functions are not always the same among plural image forming apparatuses having similar or same hardware configurations (specifications). This is because required plug-in functions may be different depending on departments of an enterprise or company.

If an image forming apparatus is broken and becomes unavailable, a previously available plug-in function cannot be used unless another image forming apparatus having the same plug-in is installed in the broken image forming apparatus. In this case, by preparing a substitute image forming apparatus and installing the same plug-in in the substitute image forming apparatus using the technique disclosed in Patent Document 1, the previously available plug-in can be used again.

However, there may be a difference between functions available in the broken image forming apparatus and functions available in the substitute image forming apparatus. Because if this difference, an order of installing the plug-in may not be the same between the broken image forming apparatus and the substitute image forming apparatus. Therefore, operability in installing the plug-ins is not always sufficient. Therefore, when plug-in configurations of plural image forming apparatuses are different in a business environment having the plural image forming apparatuses with similar hardware configurations, and one of the plural image forming apparatuses is broken and becomes unavailable, it is convenient if a plug-in function similar to that in the broken image forming apparatus is easily obtained in another one of the plural image forming apparatuses.

### Patent Document 1: Japanese Laid-Open Patent Application No. 2006-261970

### SUMMARY OF THE INVENTION

Accordingly, embodiments of the present invention provide a novel and useful information processing apparatus, information processing system and information processing program solving one or more of the problems discussed above.

One aspect of the embodiments of the present invention may be to provide an information processing apparatus that is configured to be connected to a plug-in server accumulating plug-ins downloadable to the information processing apparatus and a plug-in configuration management server managing a plug-in configuration of the information processing apparatus via a network, the information processing apparatus including a function change unit configured to install the plug-ins acquired from the plug-in server in the information processing apparatus, a memory unit configured to store configuration information of the plug-ins installed in the information processing apparatus, a registration unit configured to register the configuration information in the plug-in configuration management server, and a determination unit configured to acquire the configuration information of another information processing apparatus from the plug-in configuration management server, and compare the configuration information of the information processing apparatus with the configuration information of the other information processing apparatus to determine a difference between the plug-ins installed in the information processing apparatus and the plug-ins installed in the other information processing apparatus, whereby the function change unit acquires a missing plug-ins which are not installed in the information processing apparatus and determined with reference to the difference from the plug-in server and additionally installs the missing plug-ins in the information processing apparatus.

Another aspect of the embodiments of the present invention may be to provide an information processing system including plural information processing apparatuses configured to have plug-ins installed in these, a plug-in server configured to accumulate plug-ins downloadable to the information processing apparatuses, a plug-in configuration management server managing plug-in configurations of the information processing apparatuses, and a network configured to connect the plural information processing apparatuses, the plug-in server, and the plug-in configuration management server, whereby the information processing apparatuses include a function change unit configured to install the plug-ins acquired from the plug-in server in the information processing apparatus, a memory unit configured to store configuration information of the plug-ins installed in the information processing apparatus, a registration unit configured to register the configuration information in the plug-in configuration management server, and a determination unit configured to acquire the configuration information of another information processing apparatus from the plug-in configuration management server, and compare the configuration information of the information processing apparatus with the configuration information of the other information processing apparatus to determine a difference between the plug-ins installed in the information processing apparatus and the plug-ins installed in the other information processing apparatus, whereby the function change unit acquires a missing plug-in which is not installed in the information processing apparatus and determined with reference to the difference from the plug-in server and additionally installs the missing plug-ins in the information processing apparatus.

Another aspect of the embodiments of the present invention may be to provide a computer program embodied in a computer-readable medium and representing a sequence of instructions, which when executed by a computer included in an information processing apparatus that is configured to be connected to a plug-in server accumulating plug-ins downloadable to the information processing apparatus and a plug-in configuration management server managing a plug-in configuration of the information processing apparatus via a network, the instructions cause the computer to function as a function change unit configured to install the plug-ins acquired from the plug-in server in the information processing apparatus, a memory unit configured to store configuration information of the plug-ins installed in the information processing apparatus, a registration unit configured to register the configuration information in the plug-in configuration management server, and a determination unit configured to acquire the configuration information of another information processing apparatus from the plug-in configuration management server, and compare the configuration information of the information processing apparatus with the configuration information of the other information processing apparatus to determine a difference between the plug-ins installed in the information processing apparatus and the plug-ins installed in the other information processing apparatus, whereby the function change unit acquires a missing plug-in which is not installed in the information processing apparatus and determined with reference to the difference from the plug-in server and additionally installs the missing plug-ins in the information processing apparatus.

Additional objects and advantages of the embodiments will be set forth in part in the description which follows, and in part be obvious from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 schematically illustrates an information processing system including a network of an embodiment according to the present invention;

FIG. 2 is an example hardware configuration of an image forming apparatus of the embodiment;

FIG. 3 is an example hardware configuration of a plug-in configuration management server of the embodiment;

FIG. 4 is an example functional block chart illustrating relationships among main components of an image forming apparatus, a plug-in configuration management server and a plug-in server;

FIG. 5 schematically illustrates hardware and software configurations of the embodiment;

FIG. 6 is an example operation screen of the embodiment;

FIG. 7 is an example confirmation screen of the embodiment.

FIG. 8 is an example screen for installing a plug-in of the embodiment;

FIG. 9 is an example operation screen displayed on the operations panel of the image forming apparatus of the embodiment;

FIG. 10 schematically illustrates a dependence relationship among several plug-ins of the embodiment;

FIG. 11 is an example flow chart for confirming compatibility of a plug-in of the embodiment;

FIG. 12 schematically illustrates an information processing system including a network of a modified example 1 according to the present invention; and

FIG. 13 is an example screen for installing a plug-in of the embodiment.

### DETAILED DESCRIPTION OF THE PREFERRED EMBODIMENTS

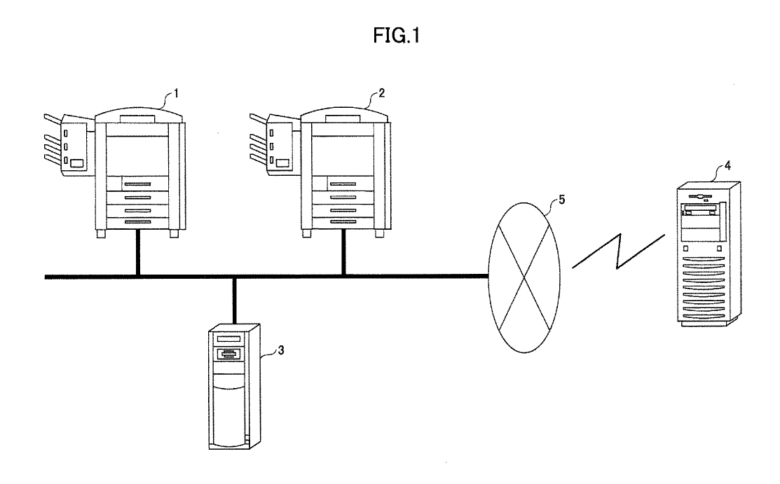

A description of an information processing apparatus as an image forming apparatus, an information processing system, and an information processing program is given below, with reference to FIG. 1 through FIG. 13 of embodiments according to the present invention.

Hereinafter, reference symbols typically designate as follows:
1: Image forming apparatus;
2: Image forming apparatus;
3: Plug-in configuration management server;
4: Plug-in server;
5: Network;
6: Administrator;
7: Service;
11: Operations panel;
11a: Input device;
11b: Display device;
12: Storage medium I/F;
12a: Drive device;
12b: Recording medium;
13: Controller;
13a: ROM;
13b: RAM;
13c: CPU;
14: Data communication I/F;
14a: Interface device;
15: Scanner;
15a: Image reading apparatus;
16: Plotter;
16a: Printer;
17: HDD;
31: CPU;
32: ROM;
33: RAM;
34: Auxiliary storage device;
35: Recording medium reading device;
36: Input device;
37: Display device;
38: Communication device;
101: Plug-in management unit;
101: UI management unit;
103: Memory unit;
104: Registration unit;
105: Determination unit;
301: Plug-in configuration management unit;
302: Storage unit;
401: Plug-in management unit; and
402: Storage unit.

### <Configuration>

First, a network structure is described to which an information processing apparatus of an embodiment is connected. FIG. 1 schematically illustrates an information processing system including a network of an embodiment according to the present invention. An image forming apparatus 1, an image forming apparatus 2, a plug-in configuration management server 3 and a plug-in server 4 are connected via a network 5. A plug-in may be added to or deleted from the image forming apparatus 1 and the image forming apparatus 2. The plug-in configuration management server 3 registers a plug-in configuration of at least one of the image forming apparatus 1, the image forming apparatus 2 and the plug-in configuration management server 3 at a timing of adding the plug-in to or deleting the plug-in from at least one of the image forming apparatus 1 and the image forming apparatus 2. The plug-in server 4 is a download server storing various plug-ins being functionally-extended software components, hereinafter simply referred to also as a component. The image forming apparatus selects an extended function, and downloads a plug-in corresponding to the extended function from the plug-in server 4. Thus, the selected plug-in is transferred to the image forming apparatus. The downloaded plug-in is installed in the image forming apparatus based on authentication information (e.g. license) of the downloaded plug-in.

In the following description, it is assumed that both of the image forming apparatuses 1 and 2 run in an ordinary state located at different sites, and the image forming apparatuses 1 and 2 have identical hardware configurations and different plug-in functions (components). Said differently, the image forming apparatus 2 has a plug-in function which is not installed in the image forming apparatus 1. Provided that the image forming apparatus 2 causes a failure and broken down, the image forming apparatus 1 is used as a substitute machine until the image forming apparatus 2 is recovered in the embodiment. This substitution is described in detail later.

Referring to FIG. 1, the image forming apparatus 1, the image forming apparatus 2 and the plug-in configuration management server 3 are connected to a local area network (LAN), and the plug-in server 4 is connected to a wide area network (WAN) which is connected to the LAN so that the image forming apparatuses located in the different sites are used in common. The above described connection is an example, and the present invention is not limited thereto. Said differently, these image forming apparatuses 1 and 2 may be connected so as to be mutually communicating. Referring to FIG. 1, the number of the image forming apparatuses is two. However, the number of the image forming apparatuses may be more than two.

### <Image Forming Apparatus>

The image forming apparatuses 1 and 2 are, for example, multi-function peripherals having plural functions such as a printer, a copier and a scanner in one body. In recent years, the MFP provides various utilization modes of not only the digital copier but also transmission of data such as images and documents through a network or by a facsimile in association with the tendencies of CPU performance upgrade, a higher capacity in memories, faster communications, sophistication of digital image technology and technology advancement in the MFP. There are many occasions in which image forming apparatuses are used in common by plural users in current office environments or the like.

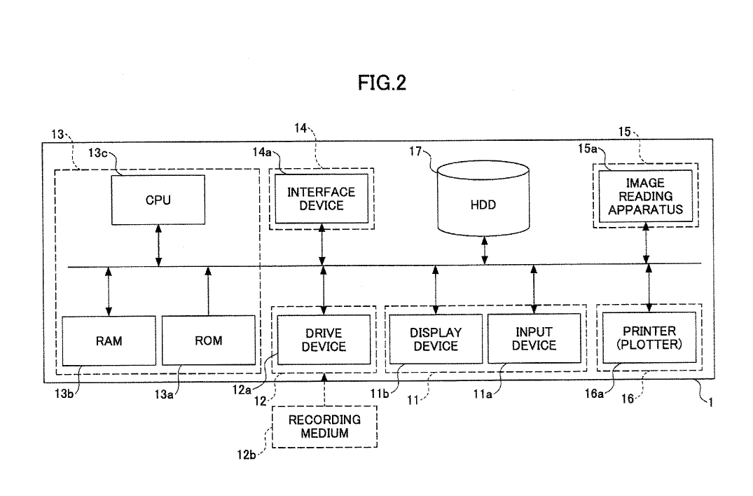

FIG. 2 illustrates an example hardware configuration of the image forming apparatuses 1 and 2 of the embodiment. The image forming apparatus 1 of the embodiment may include an operations panel 11, a storage medium I/F 12, a controller 13, a data communication I/F 14, a scanner 15, a plotter 16 and a hard disk drive (HDD) 17, which are mutually connected.

The operations panel 11 includes an input device 11a and a display device 11b. The input device 11a includes a hardware keyboard, which is used to input various operation signals into the image forming apparatus 1, and so on. The display device 11b includes a display and so on to display various information items related to image forming operations. The data communication I/F 14 includes an interface device 14a, which connects the image forming apparatus 1 to a data transmission path such as a network or a facsimile. The HDD 17 stores various data such as received document data and read image data handled in the image forming apparatus 1. The HDD 17 administrates or stores the various data using a predetermined file system or a predetermined database (DB).

The various data stored in the HDD 17 include data input from a recording medium 12b. The recording medium 12b is installed in a drive device 12a included in the storage medium I/F 12. The various data are stored in the HDD 17 from the recording medium 12b via the drive device 12a.

The controller 13 includes a read only memory (ROM) 13a, a random access memory (RAM) 13b and a central processing unit (CPU) 13c. The ROM 13a stores programs executed when the image forming apparatus 1 is booted up and various data. Further, the RAM 13b temporarily stores the various programs and data read out of the ROM 13a and the HDD 17. Further, the CPU 13c executes a program which is temporarily held by the RAM 13b. When the controller 13 receives print data via the data communication I/F 14, the controller 13 executes a program (e.g. PDL parser) which can interpret a page description language (PDL), and generates a bit map image by interpreting the print data.

The scanner 15 includes an image reading apparatus 15a to optically read a manuscript positioned on a read face of the scanner and generate read image data. The plotter 16 includes a printer 16a to print a bit map image on a recording paper by, for example, an electrophotographic process.

As described, the image forming apparatus 1 of the embodiment may demonstrate the plural functions of the copier, the image forming apparatus, the facsimile machine, the scanner or the like. The image forming apparatus 2 of the embodiment may demonstrate the plural functions of the copier, the image forming apparatus, the facsimile machine, the scanner or the like in a manner similar to that of the image forming apparatus 1.

### <Plug-In Configuration Management Server>

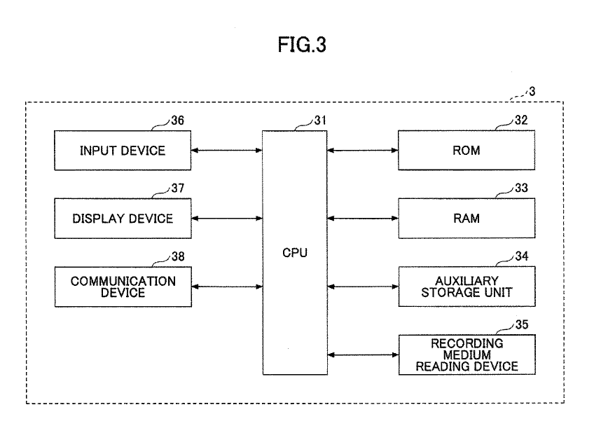

FIG. 3 illustrates an example hardware configuration of a plug-in configuration management server 3 of the embodiment. The plug-in configuration management server 3 may be an ordinary personal computer (PC) server. The major components of the plug-in configuration management server 3 are a CPU 31, a read only memory (ROM) 32, a random access memory (RAM) 33, an auxiliary storage device 34, a recording medium reading device 35, an input device 36, a display device 37 and a communication device 38. Next, the plug-in configuration management server 3 is described.

The CPU 31 includes a microprocessor and a peripheral circuit of the microprocessor (not illustrated), and controls the plug-in configuration management server 3 in its entirety. The ROM 32 is a memory storing a predetermined program (software component) executed by the CPU 31. The RAM 33 is a memory used as a working area when the CPU 31 carries out various controls by executing the predetermined program (software component) stored in the ROM 32. The auxiliary storage device 34 stores various information items including a general-purpose operating system (OS), plug-in configuration information and UI information. The auxiliary storage device 34 is, for example, a hard disk drive (HDD) which is a non-volatile memory device. The plug-in configuration information and UI information are described later. The various information items may be recorded in a recording medium such as a compact disk-ROM (CD-ROM) and a digital versatile disk (DVD) and another medium. The various information items stored in the recording media can be read via a drive device such as a recording medium reading device 35. Therefore, the information is obtainable by installing the recording medium in the recording medium reading device 35 when necessary.

The input device 36 is a device for a user to variously input through it. The input device 36 includes a mouse, a key board, a touch panel (switch) arranged to overlap a display screen of the display device 37, and the like. The display device 37 is a device for displaying information on a display screen. The display device 37 includes, for example, a liquid crystal display (LCD), a cathode ray tube (CRT) or the like. The communication device 38 communicates with the image forming apparatuses 1 and 2 via the network 5. The communication device 38 supports communications in response to a network mode such as a wired network and a wireless network.

### <Function>

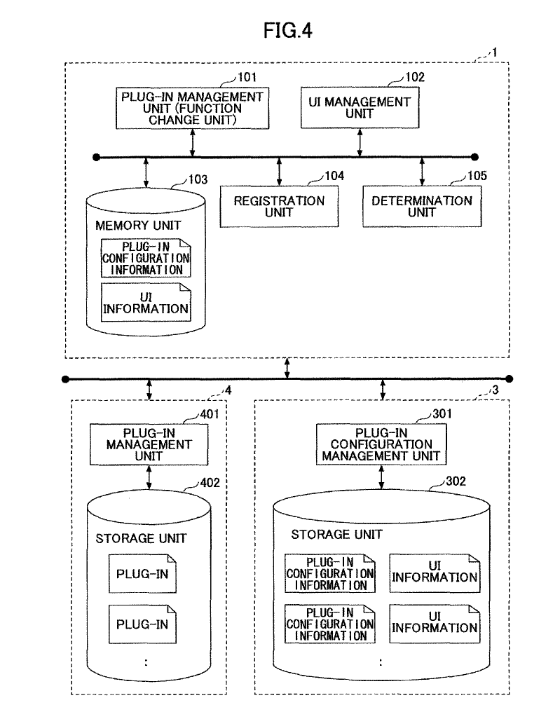

The functions of the image forming apparatus 1, the plug-in configuration management server 3 and the plug-in server 4 in the information processing system of the embodiment are described next. FIG. 4 is an example functional block chart illustrating relationships among main components of the image forming apparatus 1, the plug-in configuration management server 3 and the plug-in server 4. As illustrated in FIG. 4, the image forming apparatus 1 includes a plug-in management unit 101, a UI management unit 102, a memory unit 103, a registration unit 104 and a determination unit 105. The plug-in configuration management server 3 includes the plug-in configuration management unit 301 and a storage unit 302. The plug-in server 4 includes a plug-in management unit 401 and a storage unit 402. Description of the image forming apparatus 2 is omitted because the image forming apparatus 2 is similar to the image forming apparatus 1. The various functions are described next.

The plug-in management unit 101 manages various plug-ins for the image forming apparatus 1. For example, the plug-in management unit 101 manages the configuration information, various plug-ins, changes of functions by installing and uninstalling the plug-ins, and authentication information (e.g. license information) required in installing the plug-ins or the like. The plug-in management unit 101 generally manages the plug-ins. In the embodiment, “plug-in” designates a software component corresponding to functions newly added to the basic function of the image forming apparatus 1, a software component used in association with the basic function of the image forming apparatus 1, and so on. The plug-ins may be independently installed or uninstalled.

The UI management unit 102 controls objects of the plug-ins in response to processes such as production of an operation screen image on the operations panel or the like, display control of the operation screen image, and an instruction input from the operations panel 11 such as an operation object of an operating plug-in. The image forming apparatus 1 can customize components (e.g. buttons) forming a screen image by switching between display and nondisplay of the components or changing arrangement of the components when the operation screen is formed. Therefore, the UI management unit 102 manages UI information which is operation screen generating information of the customized operation screen.

When plug-in configuration information of the plug-ins installed in the image forming apparatus 1 or the operation screen of the image forming apparatus 1 is customized, the memory unit 103 stores the corresponding UI information. The registration unit 104 reports the plug-in configuration information and the UI information, which are stored in the memory unit 103, to the plug-in configuration management server 3 to thereby register the plug-in configuration information and the UI information in the plug-in configuration information in the plug-in management server 3. It is preferable to register the plug-in configuration information and the UI information in the plug-in configuration management server 3 when the plug-in configuration information or the UI information is changed.

When an image forming apparatus different from the image forming apparatus 1 is broken down, the determination unit 105 acquires plug-in configuration information of the broken image forming apparatus, and compares it with plug-in configuration information of the image forming apparatus 1, and determines a difference between the plug-ins of the image forming apparatus 1 and the plug-ins of the broken image forming apparatus. Detailed description is given later.

In the plug-in configuration management server 3, the plug-in configuration management unit 301 manages plug-in configuration information and UI information of image forming apparatuses managed under the plug-in configuration management unit 301. Specifically, the plug-in configuration management unit 301 acquires the plug-in configuration information and the UI information reported from the image forming apparatuses, registers and manages the plug-in configuration information and the UI information by each of the image forming apparatuses. The storage unit 302 stores the reported plug-in configuration information and the reported UI information.

In the plug-in server 4, the plug-in management unit 401 manages a group of the plug-ins managed by the storage unit 402 and information of the plug-ins in their entirety, and provides the plug-ins in response to a request of downloading the plug-ins from the image forming apparatus 1. For example, the plug-in management unit 401 manages plug-ins to be stored, function information of various plug-ins, version information of the various plug-ins, license information, dependence relationship information of between the plug-ins (e.g. a dependence relationship list), and so on. A dependence relationship may be included in one of the plug-ins on which another one of the plug-ins depends. The storage unit 402 stores various plug-ins. The plug-in is stored in a file format called a bundle which is obtained by compressing a group of program modules for realizing a predetermined function.

These functions are realized using the above-described program executed by computers including the CPU 13c and the CPU 31. Next, the information processing system, and various apparatuses and servers in the information processing system are described in detail.

### <Operation>

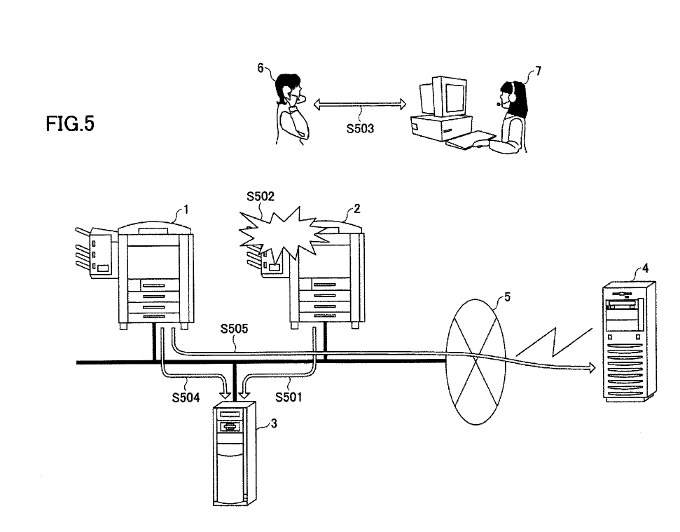

Next, a summary of operations of the information processing system of the embodiment is described. FIG. 5 schematically illustrates hardware and software configurations of the embodiment. Referring to FIG. 5, both of the image forming apparatuses 1 and 2 run in an ordinary state, and are used by respective users. The image forming apparatuses 1 and 2 have identical hardware configurations and different plug-in functions (components). The image forming apparatus 2 has a plug-in function which is not installed in the image forming apparatus 1. Provided that the image forming apparatus 2 has a failure and breaks down, the image forming apparatus 1 is used as a substitute machine until the image forming apparatus 2 is recovered in the embodiment.

(1) When the plug-in configuration information of the image forming apparatus 2 is changed by installing or uninstalling a plug-in function or updating the UI information as described above, the image forming apparatus 2 registers the plug-in configuration information of the image forming apparatus 2 in the plug-in configuration management server 3 in process S501. When the plug-in configuration information of the image forming apparatus 1 is changed by installing or uninstalling a plug-in function or updating the UI information as described above, the image forming apparatus 1 registers the plug-in configuration information of the image forming apparatus 1 in the plug-in configuration management server 3 in process S504.

(2) When any kind of failure occurs in the image forming apparatus 2, a function required to be used by a user becomes unavailable in S502.

(3) An administrator 6 who is one of users reports the failure occurrence to a maintenance staff member 7 in a service provider. The administrator 6 requests the service provider 7 to allow the administrator 6 to use the functions of the image forming apparatus 2 in the image forming apparatus 1 instead of the broken image forming apparatus 2. The service provider 7 issues license information (e.g. a license key with an expiration period) which can be used in the image forming apparatus 1 in process S503.

(4) The image forming apparatus 1 accesses the plug-in configuration management server 3 and acquires plug-in configuration information of the broken image forming apparatus 2 in process S504. Then, the image forming apparatus 1 compares the acquired plug-in configuration information with plug-in configuration information of the image forming apparatus 1, and determines a difference between plug-ins already installed in the image forming apparatus 1 and the plug-ins installed in the broken image forming apparatus 2. Said differently, the image forming apparatus 1 specifies plug-ins which have not been installed but are necessary for operating as the substitute machine for the image forming apparatus 2. Then, these plug-ins are reported to the plug-in configuration management server 3 in process S504.

(5) The image forming apparatus 1 acquires the necessary plug-ins (function) from the plug-in server 4 using the issued license information, and installs the acquired plug-ins in the image forming apparatus 1.

With the operation, the image forming apparatus 1 temporarily has the functions of the broken image forming apparatus 2. Thus, the image forming apparatus 1 operates as the substitute machine for the image forming apparatus 2 until the image forming apparatus 2 is recovered. Next, a detailed explanation of the processes is given.

As for process S501 of the above (1), the plug-in function of the image forming apparatus 2 may be installed or uninstalled by the plug-in management unit 101. The operation screen of the image forming apparatus 2 may be customized by the UI management unit 102. By changing, adding or deleting the plug-in configuration or the UI (operation screen), the plug-in configuration information or the UI information stored in the memory unit 103 is updated. At a timing of updating the plug-in configuration information or the UI information, the registration unit 104 registers the plug-in configuration information or the UI information in the plug-in configuration management server 3.

As for process S503 of the above (3), the administrator 6 uses a failure detection system instead of reporting a failure occurrence. Specifically, the service provider 7 is connected to the network 5. Therefore, the service provider may subjectively detect an occurrence of failure with the failure detection system and without a report from the administrator 6. For example, the failure may be reported from a failure detection program of the image forming apparatus 2 to the service provider 7. It is possible to determine the failure when there is no response from the image forming apparatus 2 in response to regular actions from the service provider 7 to the image forming apparatus 2. In such a case, the failure occurrence is reported from the service provider 7 to the administrator 6.

Then, the service provider 7 may issue the license information (e.g. a license key with an expiration period) which can be used in the image forming apparatus 1. The license key may be sent by verbal communication from the service provider 7 to the administrator 6. The administrator 6 inputs the license key from the operations panel 11 of the image forming apparatus 1. While the failure detection system described above is used, the service provider may remotely access the image forming apparatus 1 to input the license key. Plug-ins (function) may be paid software. Therefore, the plug-ins are ordinarily downloaded after purchasing a non-limit license key for the plug-ins when the plug-ins are newly added. The reason why the license key with the expiration period is used is to temporarily enable using of the plug-in in the image forming apparatus 1 as the substitute machine.

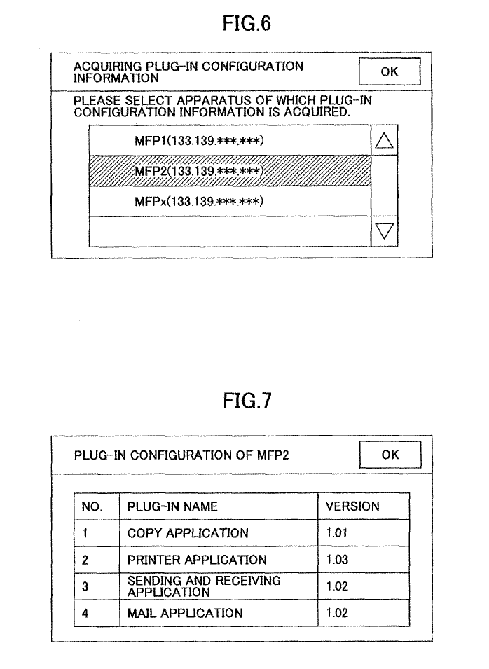

As for process S504 of the above (4), the administrator 6 operates the operations panel 11 of the image forming apparatus 1 or the like when the plug-in configuration information is acquired. FIG. 6 is an example operation screen of the embodiment. Referring to FIG. 6, a list of the image forming apparatuses which are controlled under the plug-in configuration management server 3 is displayed. When the broken image forming apparatus 2 (MFP2) is selected from the list, the image forming apparatus 1 acquires the plug-in configuration information of the image forming apparatus 2 from the plug-in configuration management server 3. While the service provider 7 and the network 5 are connected, a similar operation may be remotely carried out by the service provider 7.

FIG. 7 is an example confirmation screen of the embodiment. The confirmation screen is for plug-in configuration information of the image forming apparatus 2 which is displayed on a basis of the acquired plug-in configuration information of the image forming apparatus 2. Referring to FIG. 7, the plug-in configuration information includes at least plug-in names and version information of the plug-ins.

The determination unit 105 compares the plug-in configuration information of the image forming apparatus 1 and the plug-in configuration information of the image forming apparatus 2, and determines a difference between the plug-ins of the broken image forming apparatus 2 and the plug-ins of the image forming apparatus 1. Said differently, the image forming apparatus 1 specifies plug-ins which are not yet installed but are necessary for operating as the substitute machine for the image forming apparatus 2.

Description is given below in a case where the plug-ins of the image forming apparatus 1 as the substitute machine are a copier application, a printer application and a sending and receiving application, and the broken image forming apparatus 2 has a copier application, a printer application, a sending and receiving application and a mail application as illustrated in FIG. 7. In this case, the difference of the plug-ins is the “mail application”, and the image forming apparatus 1 lacks the mail application to work instead of the image forming apparatus 2 as the substitute machine for the image forming apparatus 2. Therefore, the determination unit 105 determines that, the mail application is necessary for the image forming apparatus 1 as the difference.

As described in reference to FIG. 7, the plug-in configuration information includes at least the plug-in names and the version information of the plug-ins. Therefore, the determination unit 105 checks the version information when the difference of the plug-ins is determined. This is because even though the plug-in names are the same, versions of the plug-ins may be different. Said differently, when the plug-in configuration information of the image forming apparatus 1 is compared to the plug-in configuration information of the image forming apparatus 2, there is a case where the plug-in functions of the plug-in configuration information of the image forming apparatuses 1 and 2 are identical but the versions of a part of the plug-ins are different. It is assumed that both of the image forming apparatuses 1 and 2 have plug-ins of copy application, and the version of the plug-in of the copy application in the image forming apparatus 1 is “1.00”, and the version of the plug-in of the copy application in the image forming apparatus 2 is “1.01”. In this case, the copy application of the image forming apparatus 2 is a newer and higher-numbered version. Therefore, the copy application of the image forming apparatus 2 may have an additional function in comparison with that in the image forming apparatus 1. Therefore, when the versions are different between the same plug-ins of the image forming apparatuses 1 and 2, the determination unit 105 determines that the plug-in of the newer version as the difference. Then, after the plug-in of the newer version is downloaded, the plug-in of the older version is overwritten (upgraded) by the plug-in of the newer version. When the version of the plug-in of the image forming apparatus 1 is higher and the version of the plug-in of the broken image forming apparatus 2 is lower, it is ordinarily unnecessary to determine the difference because functions of newer versions ordinarily include functions of older versions. However, when it is necessary to make the plug-ins completely the same, it is possible to install the plug-in of the older version in the image forming apparatus 1.

When the operation screen of the broken image forming apparatus 2 is customized, the image forming apparatus 1 acquires the UI information of the image forming apparatus 2 from the plug-in configuration management server 3 to thereby enable identically or similarly customizing the operation screen of the image forming apparatus 1.

As for process S505 of the above (5), the image forming apparatus 1 acquires the lacking plug-ins from the plug-in server 4 using the above license information (e.g. license key), and installs the acquired plug-ins in the image forming apparatus 1. In the above example, the image forming apparatus 1 acquires the plug-in application of “mail application” from the plug-in server 4, and installs the acquired plug-in in the image forming apparatus 1. The license is effective for the plug-in determined as the difference by the determination unit 105. An example of an installation screen for a plug-in is illustrated in FIG. 8.

When the UI information of the image forming apparatus 2 has already been acquired, the UI management unit 102 applies the UI information as operation screen generation information. Then, the image forming apparatus 1 can recover not only the substitution of the plug-in function but also the operation screen (user interface) of the image forming apparatus 2.

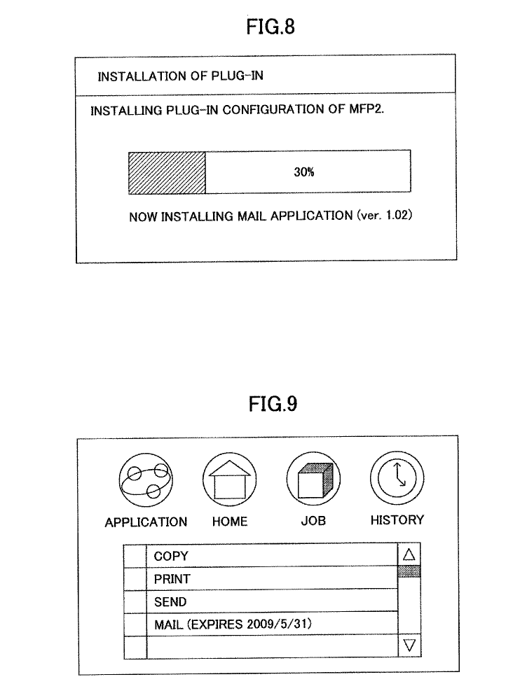

As described above, the image forming apparatus 1 can be used as the substitute machine of the image forming apparatus 2 having the same function as the broken image forming apparatus 2. FIG. 9 is an example operation screen displayed on the operations panel 11 of the image forming apparatus of the present invention. The “mail application” function with an expiration period is added. Thus, the function can be used. The operation screen the same as or similar to the operation screen of the image forming apparatus 2 can be displayed on the image forming apparatus 1.

### <Confirmation of Compatibility>

The image forming apparatus 1 confirms compatibility of the plug-in in process S504 of the above (4) and process S505 of the above (5). For example, if a certain plug-in has already been acquired by the image forming apparatus 1, there is a case where another plug-in depending on the certain plug-in is necessary to actually operate the certain plug-in. In this case, the compatibility is not confirmed.

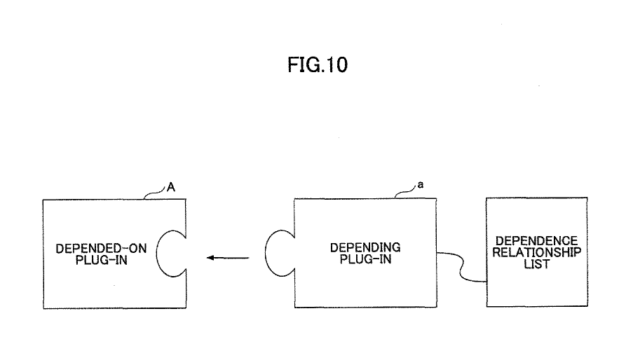

FIG. 10 schematically illustrates a dependence relationship among several plug-ins of the embodiment. In FIG. 10, a depended-on plug-in A and a depending plug-in a are illustrated. When the depending plug-in operates, the depended-on plug-in A is necessary. For example, a copy application (depending plug-in a) depends on plug-ins (depended-on plug-in A) related to “read” and “print”. Said differently, the “copy application” cannot operate without a plug-in related to “read” and “print”. For example, “mail application” (depending plug-in a) depends on a plug-in (depended-on plug-in A) related to “sending and receiving application”. Said differently, “mail application” cannot operate without a plug-in of “sending and receiving application”.

Therefore, the determination unit 105 confirms compatibility of the plug-in determined as the difference. When the plug-in depends on a certain plug-in, the image forming apparatus 1 determines whether the image forming apparatus 1 already has the depending plug-in. When the determination unit 105 determines that the image forming apparatus 1 does not have the depending plug-in, the depending plug-in may be determined as the difference. Then, the depending plug-in may be downloaded to and installed in the image forming apparatus 1 as the difference. When the compatibility is confirmed, the dependence relationship list should be referred to. As described, the dependence relationship list is managed by the plug-in server 4. Therefore, when the determination unit 105 confirms the compatibility, it is preferable to acquire the dependence relationship list from the plug-in server 4. This is because it is necessary to check whether the dependence relationship included in the depending plug-in and the dependence relationship included in the depended-on plug-in, depended by the depending plug-in, conform after once acquiring the depending and depended-on plug-ins with reference to the dependence relationship lists in the depending and depended-on plug-ins.

When a certain plug-in is acquired as the difference, and a relationship between the acquired plug-in and an existing plug-in is an exclusion relationship, hereinafter also referred to as a reversed dependence relationship, the acquired plug-in may not be installed. Therefore, when the plug-in is installed it is necessary to consider a relationship with the other plug-ins. In order to confirm the exclusion relationship, the dependence relationship list may be referred to in a manner similar to the above process.

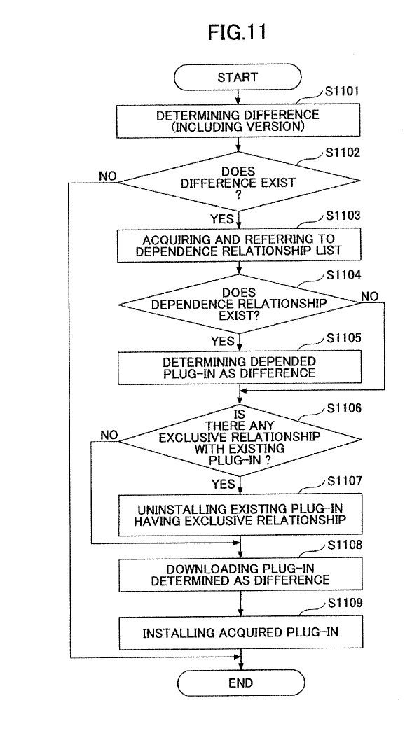

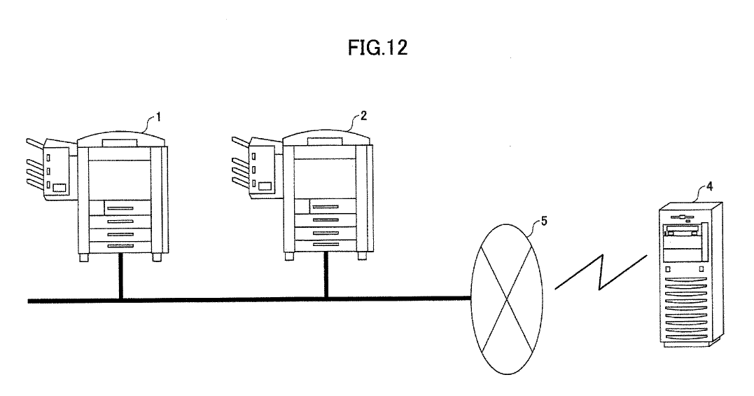

FIG. 11 is an example flow chart for explaining confirmation of compatibility of plug-ins of the embodiment. The example process flow includes steps similar to process S504 of the above (4) and process S505 of the above (5).

The determination unit 105 determines the difference between the plug-in configuration information of the image forming apparatus 1 and the plug-in configuration information of the broken image forming apparatus 2 as described above by comparing these plug-in configuration information items in step S1101. At this time, the difference is determined not only when the plug-ins are different but also when the versions of the same plug-ins are different as described above.

When there is no difference in the plug-ins in step S1102, the process immediately ends because the image forming apparatus 1 and the broken image forming apparatus have the same configuration. When there is a difference between the plug-ins in step s1102, the determination unit 105 acquires the dependence relationship list from the plug-in server 5 and refers to the dependence relationship list in step S1103 to confirm compatibility of installing a plug-in. Here, a reference symbol D designates a different plug-in of the image forming apparatus 2 used for installation. It is confirmed whether a depended-on plug-in P on which the different plug-in D depends exists in the broken image forming apparatus in step S1104. When the different plug-in D has any dependence relationship, the determination unit 105 determines a depended-on plug-in P depended on by the different plug-in D as the difference in step S1105.

Next, the determination unit 105 confirms whether there is any existing plug-in B of the own image forming apparatus, being in the exclusion relationship with the different plug-in D, based on the dependence relationship list in step S1106. In a case where there is the existing plug-in B in the exclusion relationship with the different plug-in D, the plug-in management unit 101 uninstalls the existing plug-in B in step S1107. Due to the uninstallation of the existing plug-in B, a part of functions usable in the image forming apparatus 1 becomes unavailable.

The plug-in management unit 101 acquires the different plug-in by downloading the different plug-in from the plug-in server 4 in step S1108, and installs the acquired plug-in in the image forming apparatus 1 in step S1109. Said differently, a plug-in which is stored in the storage unit 402 of the plug-in server 4 and is the same as the difference plug-in D is acquired and installed in the image forming apparatus 1. In a case where the difference plug-in D depends on the depended-on plug-in P, a plug-in which is stored in the storage unit 402 of the plug-in server 4 and is same as the difference plug-in D and a plug-in which is stored in the storage unit 402 of the plug-in server 9 and is same as the difference plug-in P are acquired and installed in the image forming apparatus 1.

In a case where the difference is determined due to the version difference as described above, the compatibility is confirmed with respect to the versions. Referring to FIG. 7, it is assumed that version “1.02” of “mail application” requires version “1.02” of “sending and receiving application” in its operation due to a dependence relationship between “mail application” and “sending and receiving application”. In this case, if the own image forming apparatus 1 (substitute machine) has the existing plug-in of version “1.00” of “sending and receiving application”, version “1.00” of “sending and receiving application” may not be used. Said differently, the version of the depended-on plug-in, on which version “1.02” of “mail application” depends based on the dependence relationship list, is confirmed in step S1104. The determination unit 105 determines version “1.02” of “sending and receiving application” as the difference. The plug-in management unit 101 acquires “1.02” of “sending and receiving application” from the plug-in server 4.

As described, the own image forming apparatus 1 installs the plug-ins determined as the difference based on the comparison using the plug-in configuration information on the image forming apparatus 1. Thus, the own image forming apparatus 1 has the functions the same as the functions of the broken image forming apparatus 2, and operates as the substitute machine for the broken image forming apparatus 2. Further, the compatibility of the plug-ins in the image forming apparatus 1 is confirmed. Further, the compatibility of the plug-ins in the own image forming apparatus 1 is confirmed. For example, the compatibility may be confirmed by determining whether the dependence relationship between the different plug-in and the existing plug-in accepts the different plug-in, whether the exclusion relationship between the different plug-in and the existing plug-in accepts the different plug-in, whether the different plug-in may be installed without problem, and whether the function of the installed different plug-in is appropriate.

### <Recovery>

The image forming apparatus 1 temporarily operates as the substitute machine for the broken image forming apparatus 2. However, when the image forming apparatus 2 is recovered and ready to provide of the original function of the image forming apparatus 2, the image forming apparatus 1 is required to return to the original state of the image forming apparatus 1. For this, the process described above may be applied.

For example, the determination unit 105 of the image forming apparatus 1 compares the present plug-in configuration information of the image forming apparatus 1 with the past plug-in configuration information before installing the difference plug-in to thereby determine a difference between the present and past plug-ins. The present plug-in configuration information of the image forming apparatus 1 is stored in the memory unit 103. The past plug-in configuration information may be acquired by accessing the plug-in configuration management server 3. Then, the UI information for generating the operation screen before the different plug-in is installed is also acquired.

The image forming apparatus 1 uninstalls the plug-in determined as the difference. Further, the original UI information is also applied to the operation screen. In a case where there has been the plug-in deleted due to the exclusion relationship with the installed different plug-in, the deleted plug-in is acquired from the plug-in server 4 and installed in the image forming apparatus 1. Since the license key corresponding to the acquired plug-in had originally existed in the image forming apparatus 1 and therefore is already acquired (purchased), the license key may be used as in the past.

Thus, the image forming apparatus 1 can be returned to the original state before functioning as the substitute machine.

### Modified Example 1

In modified example 1, a more simple structure is described. The plug-in configuration management server 3 is omitted, and the plug-in configuration information and the UI information are mutually owned by the broken image forming apparatus 2 and the image forming apparatus 1 as the substitute machine. FIG. 12 schematically illustrates a network of an information processing system of the modified example 1 according to the present invention. In comparison with FIG. 1, the plug-in configuration management server 3 is omitted.

The memory unit 103 of the image forming apparatus 1 of the modified example stores not only the configuration information and the UI information of plug-ins of the image forming apparatus 1 but also the configuration information and the UI information of plug-ins of the image forming apparatus 2. The registration unit 104 reports the plug-in configuration information and the UI information, which are stored in the memory unit 103, to the other image forming apparatuses instead of the plug-in configuration management server 3. Thus, the plug-in configuration information and the UI information may be registered in the other image forming apparatuses instead of the plug-in configuration management server 3.

In a case where the image forming apparatus 2 is broken down, the plug-in configuration information may be acquired from the memory unit of the image forming apparatus 1 instead of acquiring it from the plug-in configuration management server 3. As described above, the information processing apparatus of the embodiment may be realized with the more simple structure.

### Modified Example 2

In modified example 2, it is not always necessary to install exactly the same functions as those of the broken image forming apparatus 2 in the image forming apparatus 1. Said differently, only a function required to be used by a user may be selected, and the plug-in corresponding to the selected function may be installed in the substitute machine.

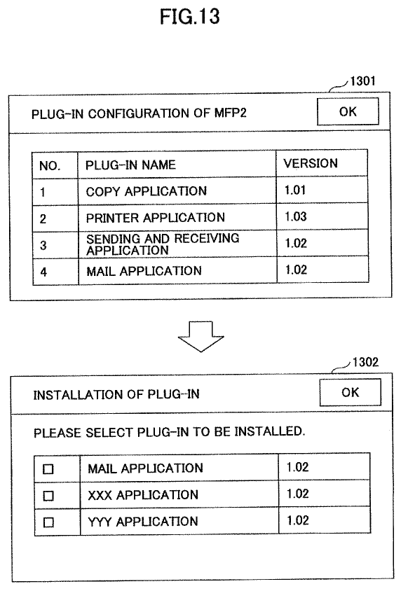

An example of a selection screen for plug-ins to be installed is illustrated in FIG. 13. Referring to FIG. 13, when the image forming apparatus 1 as the substitute machine acquires the plug-in configuration information of the image forming apparatus 2, the confirmation screen 1301 is displayed on the display device 11b as described in FIG. 7. The plug-ins determined as the difference by the determination unit 105 are displayed on a selection screen 1302 to show the plug-ins selectable by a user. In the example illustrated in FIG. 13, “mail application”, “XXX application” and “YYY application” are displayed on the selection screen 1302. The user may select the plug-in to be installed by marking in a check box, for example. The plug-in management unit 101 acquires (downloads) the selected plug-in from the plug-in server 4, and installs the acquired plug-in in the image forming apparatus 1.

In this way, it becomes possible to provide only the function required by the user in the image forming apparatus 1. Thus, the substitute machine can be quickly realized. Further, it is possible to reduce a so-called downtime while the required plug-in function cannot be used.

As described, the embodiment of the present invention provides an information processing apparatus, an information processing system and an information processing program which enable reproducing functions the same as expected functions of a broken machine by using a substitute machine.

Further, functions similar to the expected functions of the broken machine are quickly reproduced by using the substitute machine.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made thereto without departing from the spirit and scope of the invention.

This patent application is based on Japanese Priority Patent Application No. 2009-115813 filed on May 12, 2009, the entire contents of which are hereby incorporated herein by reference.

What is claimed is:

1. An information processing apparatus that is configured to be connected to a plug-in server accumulating plug-ins downloadable to the information processing apparatus and a plug-in configuration management server managing a plug-in configuration of the information processing apparatus via a network, the information processing apparatus comprising:
a function change unit configured to install the plug-ins acquired from the plug-in server in the information processing apparatus;
a memory unit configured to store configuration information of the plug-ins installed in the information processing apparatus;
a registration unit configured to register the configuration information in the plug-in configuration management server; and
a determination unit configured to acquire the configuration information of another information processing apparatus from the plug-in configuration management server, and compare the configuration information of the information processing apparatus with the configuration information of the other information processing apparatus to determine a difference between the plug-ins installed in the information processing apparatus and the plug-ins installed in the other information processing apparatus,
wherein the function change unit acquires a missing plug-in which is not installed in the information processing apparatus and determined with reference to the difference from the plug-in server and additionally installs the missing plug-ins in the information processing apparatus.

2. The information processing apparatus according to claim 1, further comprising:
a UI management unit configured to generate an operation screen which is enabled to be customized and display the operation screen,
wherein the memory unit stores generation information of the operation screen,
the registration unit registers the generation information of the operation screen in the plug-in configuration management server,
the function change unit acquires the missing plug-in and the generation information of the operation screen of the other information processing apparatus from the plug-in server, and
the UI management unit generates and displays the operation screen using the generation information of the operation screen of the other information processing apparatus.

3. The information processing apparatus according to claim 1,
wherein when one of the plug-ins determined as the difference is in a dependence relationship with another one of the plug-ins, the determination unit determines the other plug-in as the difference.

4. The information processing apparatus according to claim 1,
wherein the function change unit is further configured to uninstall the plug-ins,
the function change unit deletes, when the plug-in determined as the difference by the determination unit is in an exclusion relationship with any one of the plug-ins installed in the information processing apparatus, the any one of the plug-ins.

5. The information processing apparatus according to claim 1,
wherein the determination unit further determines the difference between a version of the plug-ins installed in the information processing apparatus and the version of the plug-ins installed in the other information processing apparatus.

6. The information processing apparatus according to claim 1,
wherein the function change unit additionally installs a selected plug-in selected among the missing plug-ins in the information processing apparatus.

7. The information processing apparatus according to claim 1,
wherein the determination unit further determines, after additionally installing the missing plug-ins in the information processing apparatus, a recovery difference of configuration information between the information processing apparatus after installing the missing plug-ins in the information processing apparatus and configuration information of the information processing apparatus before installing the missing plug-ins in the information processing apparatus, and deletes the installed missing plug-ins determined as the recovery difference.

8. An information processing system comprising:
plural information processing apparatuses configured to have plug-ins installed therein;
a plug-in server configured to accumulate plug-ins downloadable to the information processing apparatuses;
a plug-in configuration management server managing plug-in configurations of the information processing apparatuses; and
a network configured to connect the plural information processing apparatuses, the plug-in server, and the plug-in configuration management server,
wherein the information processing apparatuses comprises:
a function change unit configured to install the plug-ins acquired from the plug-in server in the information processing apparatus;
a memory unit configured to store configuration information of the plug-ins installed in the information processing apparatus;
a registration unit configured to register the configuration information in the plug-in configuration management server; and
a determination unit configured to acquire the configuration information of another information processing apparatus from the plug-in configuration management server, and compare the configuration information of the information processing apparatus with the configuration information of the other information processing apparatus to determine a difference between the plug-ins installed in the information processing apparatus and the plug-ins installed in the other information processing apparatus,
wherein the function change unit acquires a missing plug-in which is not installed in the information processing apparatus and determined with reference to the difference from the plug-in server and additionally installs the missing plug-ins in the information processing apparatus.

9. The information processing system according to claim 8,
wherein the information processing apparatus further comprises
a UI management unit configured to generate an operation screen which is enabled to be customized and display the operation screen,
wherein the memory unit stores generation information of the operation screen,
the registration unit registers the generation information of the operation screen in the plug-in configuration management server,
the function change unit acquires the missing plug-in and the generation information of the operation screen of the other information processing apparatus from the plug-in server, and
the UI management unit generates and displays the operation screen using the generation information of the operation screen of the other information processing apparatus.

10. The information processing system according to claim 8,
wherein when one of the plug-ins determined as the difference is in a dependence relationship with another one of the plug-ins, the determination unit determines the other plug-in as the difference.

11. The information processing system according to claim 8,
wherein the function change unit is further configured to uninstall the plug-ins,
the function change unit deletes, when the plug-in determined as the difference by the determination unit is in an exclusion relationship with any one of the plug-ins installed in the information processing apparatus, the any one of the plug-ins.

12. The information processing system according to claim 8,
wherein the determination unit further determines the difference between a version of the plug-ins installed in the information processing apparatus and the version of the plug-ins installed in the other information processing apparatus.

13. The information processing system according to claim 8,
wherein the function change unit additionally installs a selected plug-in selected among the missing plug-ins in the information processing apparatus.

14. The information processing system according to claim 8,
wherein the determination unit further determines, after additionally installing the missing plug-ins in the information processing apparatus, a recovery difference between configuration information of the information processing apparatus after installing the missing plug-ins in the information processing apparatus and configuration information of the information processing apparatus before installing the missing plug-ins in the information processing apparatus, and deletes the installed missing plug-ins determined as the recovery difference.

15. A computer program embodied in a computer-readable medium and representing a sequence of instructions, which when executed by a computer included in an information processing apparatus that is configured to be connected to a plug-in server accumulating plug-ins downloadable to the information processing apparatus and a plug-in configuration management server managing a plug-in configuration of the information processing apparatus via a network, the instructions cause the computer to function as:
a function change unit configured to install the plug-ins acquired from the plug-in server in the information processing apparatus;
a memory unit configured to store configuration information of the plug-ins installed in the information processing apparatus;
a registration unit configured to register the configuration information in the plug-in configuration management server; and
a determination unit configured to acquire the configuration information of another information processing apparatus from the plug-in configuration management server, and compare the configuration information of the information processing apparatus with the configuration information of the other information processing apparatus to determine a difference of the plug-ins installed in the information processing apparatus and the plug-ins installed in the other information processing apparatus,
wherein the function change unit acquires a missing plug-in which is not installed in the information processing apparatus and determined with reference to the difference from the plug-in server and additionally installs the missing plug-in in the information processing apparatus.

16. The computer program according to claim 15,
wherein the instructions cause the computer to further function as
a UI management unit configured to generate an operation screen which is enabled to be customized and display the operation screen,
wherein the memory unit stores generation information of the operation screen,
the registration unit registers the generation information of the operation screen in the plug-in configuration management server,
the function change unit acquires the missing plug-in and the generation information of the operation screen of the other information processing apparatus from the plug-in server, and
the UI management unit generates and displays the operation screen using the generation information of the operation screen of the other information processing apparatus.
